(19) United States
(12) Patent Application Publication
(10) Pub. No.: US 2016/0100711 A1
(43) Pub. Date: Apr. 14, 2016

(54) Method and Apparatus for Draining a Liquid from a Food Item

(71) Applicant: David R. Sun, Placentia, CA (US)

(72) Inventor: David R. Sun, Placentia, CA (US)

(21) Appl. No.: 14/509,930

(22) Filed: Oct. 8, 2014

(51) Int. Cl. A47J 36/20; A23L 1/015

(52) U.S. Cl. CPC A47J 36/20; A23L 1/015; A23V 2002/00

(57) ABSTRACT

A device for removing the liquid stored or contained within a food item. The device comprises a first half and second half that are coupled together via hinge. Disposed on the inner surfaces of the first and second halves are a plurality of protrusions, each of which comprise a sharpened tip and a scalloped indentation for aiding in the draining of the liquid from the food item. Once a food item is placed in the device, the two halves are brought together and squeezed which drives the protrusions into the food item. Liquid within the food item then seeps out of the food item, down the scalloped indentation of the protrusions, and then finally out of the nozzle tip of the device. Once the desired amount of liquid has been removed, the device is opened and the food item is lifted out of the device.

### BACKGROUND

1. Field of the Technology

The disclosure relates to the field of food preparation items, specifically a device for draining liquid from an elongated food item.

2. Description of the Prior Art

Americans as a whole consume an inordinate sum of hot dogs, sausages, and other grilled or cooked items during a variety of events for a variety of reasons. Recently however, many individuals have become concerned with reducing the amount of calories they consume and maintaining a healthy diet. Traditionally however many types of hot dogs or sausages have a high fat content which make them prohibitive to many individuals, particularly those in poor health or who have medical conditions such as hypertension or issues with obesity.

Several devices and methods have been developed over the years which attempt to reduce the fat content in a given food item and yet maintain a simple ease of use for the consumer. Most notably, many of these devices have been in the form of a number of different grills or barbeques with a clam shell configuration which simply presses the liquid fat out of a food item and then directs the lit away from the food item and into a separate collection pan. Other devices such as skewers, rotisserie spits, and the like have been used which rotate the food item as it cooks, letting the liquid fat drip and fall away.

A special problem arises however when the consumer attempts to cook an elongated food item such as a hot dog or sausage. Hot dogs and sausages by their inherent nature comprise a portion of meat which is encapsulated within a natural casing, meaning that as the hot dog or sausage is being cooked, any fat which is liquefied tends to stay within the hot dog or sausage itself and does not seep or exit the surface of the item until it is consumed by the consumer. Elongated food items may be cooked in a grill press, however it order for the grill to effectively remove the fat contained within the elongated food item, the grill must pierce the casing of the food item which is a purpose that the grill is ill suited for and which may jeopardize the structural integrity of the food item and render it unusable or unappetizing. A consumer may also simply use paper towels or other similar means to squeeze the food item and thus remove any liquefied fat that way. However this method can prove cumbersome and messy, especially when the elongated food item is still hot to the touch.

What is needed therefore is an apparatus and method which allows a consumer to remove the liquefied fat from within an elongated food item such as a hot dog or a sausage without burning their hand or destroying the general shape of the food item.

### BRIEF SUMMARY

The invention includes a device for removing liquid from a food item. The device includes a first half coupled to a second half which by a hinge. The inner surfaces of the first half and second half include a number of protrusions thereon and the first half and second half each have a substantially concave shape so that a cylinder is formed when the first half and second half are brought together in a closed position.

In one embodiment, the device has a proximal end with an aperture defined therein and a distal end with a tapered nozzle tip.

In another embodiment, the plurality of protrusions of the device each have a scalloped indentation and a sharpened tip.

In another embodiment, the device has a tab disposed on its first half and a groove disposed on its second half. The tab is configured to fit within the groove when the first and second halves are brought together to form a cylinder about the food item.

In yet another embodiment, the plurality of protrusions disposed on the inner surfaces of the first half and second half are configured in a matching staggered pattern for a food item comprising a substantially elongated shape.

In one particular embodiment, the first half and the second half are comprised of a resilient, flexible plastic. The plurality of protrusions are in turn comprised of a differing plastic that is more rigid than the plastic comprising the first half and second half.

The invention also includes a method for removing the liquid from a food item. The method includes inserting the food item into a device comprising a first half and a second half, closing the device by rotating the first half of the device with regard to the second half of the device, squeezing the first half and second half of the device, draining liquid contained within the food item from the device, and removing the food item from the food device.

In one embodiment, the method step of closing the device by rotating the first half of the device with regard to the second half of the device comprises rotating the first half or the second half about a hinge.

In an alternative embodiment, the method step of closing the device by rotating the first half of the device with regard to the second half of the device include bringing a tab disposed on the first half in close proximity to a groove disposed on the second half and then inserting the tab into the groove. More particularly, inserting the tab into the groove comprises inserting the tab into the groove all along a combined longitudinal length of the first and second halves.

In one embodiment, the method step of squeezing the first half and second half of the device comprises pressing the first and second halves of the device towards each other and then driving a plurality of protrusions disposed on each of the inner surfaces of the first and second halves into the food item. Draining the liquid contained within the food item from the device is then accomplished by directing the liquid down a scalloped indentation defined within each of the plurality of protrusions.

In a separate embodiment, the method step of draining the liquid contained within the food item from the device comprises maintaining the device in a substantially vertical position such that liquid removed from the food item exits or drips from the device via a nozzle tip disposed in a distal end of the device.

In yet another embodiment, the method step of squeezing the first half and second half of the device comprises maintaining a constant air pressure between the inside and the outside of the device via an aperture defined in a proximal end of the device.

In another embodiment, the method step of removing the food item from the device includes releasing a tab disposed on the first half that has been temporarily coupled to a groove disposed on the second half, rotating the first half about a hinge with respect to the second half, and then picking up the food item from the first or second half of the device. More particularly, rotating the first half about a hinge with respect to the second half further includes removing a plurality of protrusions located on the first half or second half from the food item.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a perspective view of the device with the device being in a partially open position.

FIG. 2 is a side view of device seen in FIG. 1.

FIG. 3 is a top down view of the device seen in FIG. 1 with the device in a fully open position.

FIG. 4 is a perspective view of the device seen in FIG. 1 with an elongated food item placed inserted into the device.

FIG. 5 is a frontal view of the device seen in FIG. 4 with an elongated food item placed therein.

FIG. 6 is a side view of the device seen in FIG. 4 with an elongated food item placed therein.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

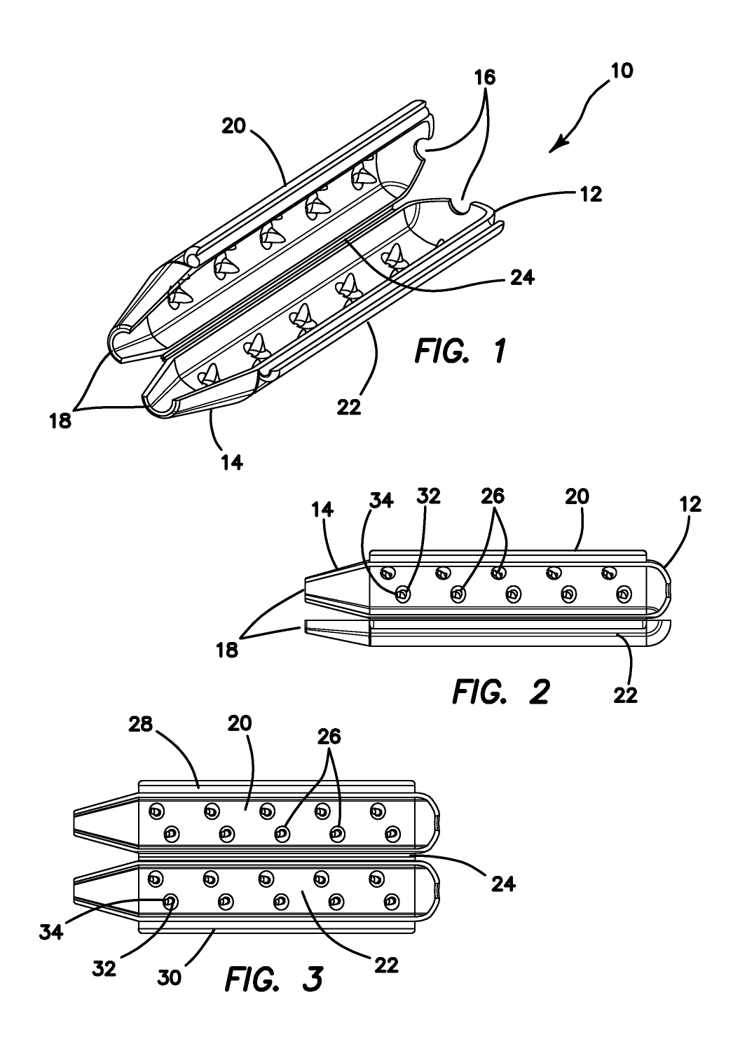

The current apparatus is a device for removing the fat stored within an elongated food item and is generally denoted by reference numeral 10 as seen in FIG. 1. For definitional purposes, an “elongated food item” is any consumable food item that comprises a substantially longer length relative to the item's width. Examples include but are not limited to hot dogs, sausages, and the like.

As seen in FIGS. 1 and 2, the device comprises a substantially elongated cylindrical shape with a proximal end 12 and a distal end 14. The proximal end 12 comprises a substantially rounded or hemispherical shape. Defined in the center of the proximal end 12 is an aperture 16 which allows air pass to and from the internal compartment of the device. The distal end 14 is substantially cone shaped with a tapered width that leads to a nozzle tip 18.

The whole of the device 10 is comprised of a resilient plastic or plastic composite that is sufficiently durable to withstand frequent use as detailed below, yet also flexible and malleable enough for nearly any user. In one particular embodiment, the plastic material used to comprise the device is up to 1 mm in thickness.

As best seen in FIGS. 1 and 3, the device 10 comprises a bifurcated or clam shell design with two halves, specifically a first half 20 and a second half 22. The halves 20, 22 are coupled together via a flexible hinge 24 that is disposed over a substantial longitudinal length between the halves 20, 22 as seen in FIG. 3. The hinge 24 is preferably comprised of plastic and is flexible enough so that either half 20, 22 may be freely rotated with respect to one another.

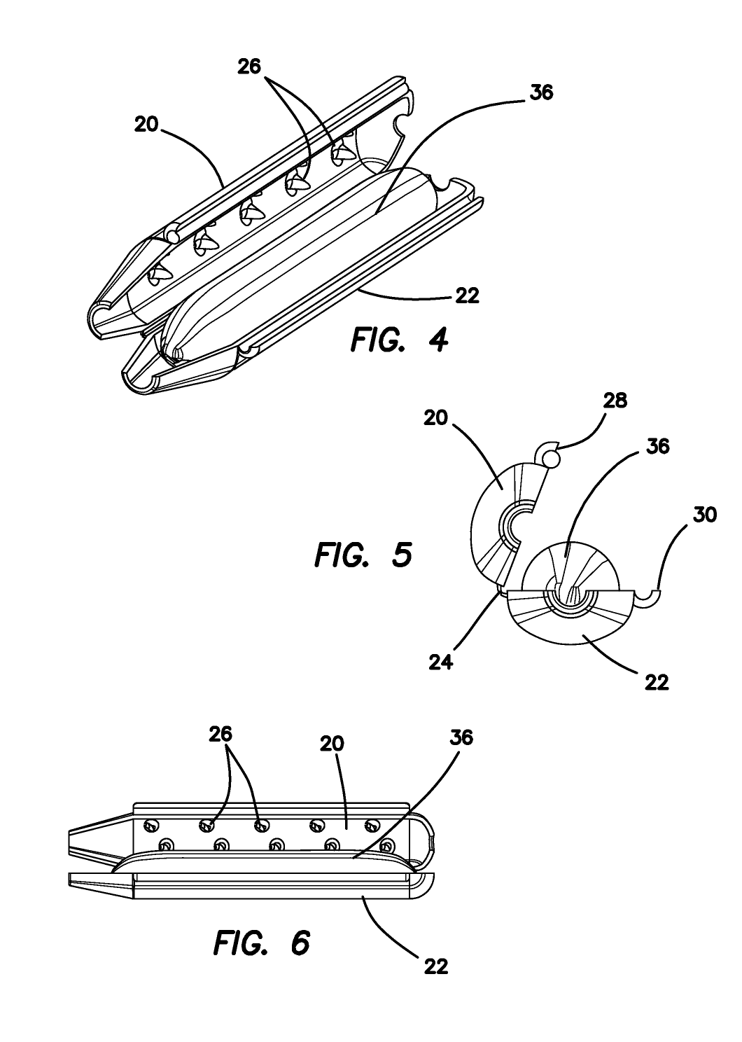

Turning to FIGS. 3 and 5, the device 10 also comprises means for temporarily coupling together and thus forming a solid cylindrical object sufficient for enclosing or accommodating an elongated food item therein. Specifically, the first half 20 comprises a male tab 28 disposed along a substantial portion of its longitudinal length, while the second half 22 comprises a female groove 30 disposed along a substantial portion of its own respective longitudinal length. When the two halves 20, 22 are brought together, the tab 28 is brought into contact with the groove. The user then continues to press the tab 28 and groove 30 together until the tab 28 snaps into position within the groove 30 and is held there by a friction fit. With the tab 28 inserted into the groove 30, the two halves 20, 22 of the device 10 are sufficiently held together all long their respective longitudinal lengths. To release the two halves 20, 22, the user manipulates the tab 28 and groove 30 until the tab 28 is free from the groove 30 which allows the two halves 20, 22 to be swung apart. While it may be seen in FIGS. 3 and 5 that the tab 28 itself comprises a substantially cylindrical shape with a circular cross section and that the groove 30 comprises a corresponding “U” shape for accommodating the tab 28, it is to be expressly understood that other means for temporarily coupling the first half 20 and second half 22 together may be used without departing from the original spirit and scope of the invention. For example, other pressure fit configurations not expressly disclosed herein including snaps, clasps, latches, or the like may be used to achieve roughly the same result as with what is currently disclosed above and are well within the scope of one ordinarily skilled in the art.

Both the first half 20 and the second half 22 as seen in FIGS. 1-3 comprise a concave or rounded shape with each of the halves 20, 22 providing a hollow or empty space there between when the device 10 is in the closed position. Disposed throughout the inner surface of each of the halves 20, 22 are a plurality of protrusions 26. Each protrusion 26 comprises an angled or sharpened tip 32. Additionally, each protrusion 26 comprises a sufficiently scalloped indentation 34 so as to provide a means for the liquefied fat to exit and drain away from the elongated food item once it has been placed in the device 10 as detailed further below. Each half 20, 22 has its respective plurality of protrusions 26 disposed throughout its longitudinal length in a staggered pattern as best seen in FIG. 3, however other symmetric or asymmetric configurations may be used by one skilled in the art without significantly departing from the scope of the invention.

To use the device 10, a user first manipulates the device 10 so that the first half 20 and second half 22 are in the open position as seen in FIGS. 1 and 3. The user then places an elongated food item 36, represented in FIGS. 4-6 as a hot dog, into the device 10 by placing the food item 36 into the concave space of one of the halves 20, 22, for example the second half 22 as seen in FIGS. 4 and 6. After the food item 36 has been placed, the user then closes the device 10 by rotating the half 20, 22 not accommodating the food item 36 about the hinge 24, in this case, the first half 20 as seen in the figures. The user seals the two halves 20, 22 of the device 10 together by bringing the tab 28 into contact with the groove 30 as detailed above, thus encapsulating or enclosing the food item 36 within the device 10 on all sides. The user then grips the device 10 and begins to squeeze the device 10, thus slightly deforming the first and second halves 20, 22 and bringing their respective inner surfaces in closer proximity to one another. As the inner surfaces of the halves 20, 22 are moving closer together, the protrusions 26 on either half 20, 22 press into the food item 36 with the sharpened tips 32 piercing into the surface of the food item 36. The user continues to squeeze the device 10, driving the protrusions deeper into the food item 36. The scalloped indentation 34 on each protrusion 26 creates space or a pathway as the protrusion 26 is being pushed further and further into the food item 36. Liquid stored within the food item 36, for example liquefied fat or grease, is squeezed into the scalloped indentation 34 by the incoming protrusion 26 and its corresponding sharpened tip 32. The shaped of the scalloped indentation 34 allows the liquid to be effectively drained from the food item 36 and further directions the liquid towards the respective inner surfaces of the first and second half 20, 22.

While the disclosure above relates that the elongated food item 36 which is placed within the device 10 is a hot dog, it should be expressly understood that the device 10 may be scaled either up or down in size in order to accommodate differing food items other than what is shown and described above. For example, the device 10 may be fabricated to be proportionately smaller to accommodate smaller food items such as breakfast sausages, and correspondingly, the device 10 may also be fabricated to be proportionally larger as is known in the art to accommodate larger food items such as sausage links or corn on the cob.

Additionally, while the protrusions 26 described above comprise a substantially conical shape with a scalloped indentation, it should be expressly understood that the protrusions may comprise any equivalent functional shape now known or later devised without departing from the original spirit and scope of the invention. For example, the protrusions 26 may also comprise a substantially bladed or sharpened edge shape, or a pyramid or tetrahedronal shape, among others.

The user preferably squeezes the device 10 while it is being held in a substantially vertical orientation, specifically with the distal end 14 pointed downwards. Liquid which has been removed from the food item 36 by the protrusions 26 flows down the inner surface of the first and second halves 20, 22 towards the distal end 14 and then out of the device 10 through the nozzle 18. The user continues to squeeze the device 10 until the user decides to stop or when all the liquid has been removed from the food item 36. The aperture 16 in the proximal end 12 ensures the free flow of air passing to and from the device 10 as it is being squeezed, thus preventing any liquid which has been removed from the food item 36 but has not yet exited the device 10 from being inadvertently sucked back up into the food item 36 when the user releases their grip on the device 10.

When the user has stopped squeezing the device 10, the user may open the device 10 by releasing the tab 28 from the groove 30 as discussed above and rotating the first and second halves 20, 22 about the hinge 24, thus reversing the course of the protrusions 26 and pulling them free from the food item 36. The user is then free to remove the food item 36 from the device 10 and repeat as needed. The device 10 is preferably comprised of washing machine safe plastic or plastic composite for ease of cleaning.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

I claim:

1. A device for removing liquid from a food item comprising:
a first half;
a second half coupled to the first half by a hinge; and
a plurality of protrusions disposed on an inner surface of the first half and second half,
wherein the first half and second half each comprise a concave shape so that a cylinder is formed when the first half and second half are brought together in a closed position.

2. The device of claim 1 wherein the device has a proximal end comprising an aperture defined therein and a distal end comprising a tapered nozzle tip.

3. The device of claim 1 wherein the plurality of protrusions each comprise a scalloped indentation and a sharpened tip.

4. The device of claim 1 further comprising:
a tab disposed on the first half; and
a groove disposed on the second half,
wherein the tab is configured to fit within the groove when the first and second halves are brought together to form a cylinder about the food item.

5. The device of claim 1 where the plurality of protrusions disposed on the inner surfaces of the first half and second half are configured in a matching staggered pattern for a food item comprising an elongated shape.

6. The device of claim 1 wherein the first half and the second half are comprised of a resilient, flexible plastic.

7. The device of claim 6 where the plurality of protrusions are comprised of a second plastic that is more rigid than the plastic comprising the first half and second half.

8. A method for removing the liquid from a food item comprising:
inserting the food item into a device comprising a first half and a second half;
closing the device by rotating the first half of the device with regard to the second half of the device;
squeezing the first half and second half of the device;
draining liquid contained within the food item from the device; and
removing the food item from the food device.

9. The method of claim 8 where closing the device by rotating the first half of the device with regard to the second half of the device comprises rotating the first half or the second half about a hinge.

10. The method of claim 8 where closing the device by rotating the first half of the device with regard to the second half of the device comprises:
bringing a tab disposed on the first half in close proximity to a groove disposed on the second half; and
inserting the tab into the groove.

11. The method of claim 10 where inserting the tab into the groove comprises inserting the tab into the groove all along a combined longitudinal length of the first and second halves.

12. The method of claim 8 where squeezing the first half and second half of the device comprises pressing the first and second halves of the device towards each other and driving a plurality of protrusions disposed on each of the inner surfaces of the first and second halves into the food item.

13. The method of claim 12 where draining liquid contained within the food item from the device comprises directing the liquid down a scalloped indentation defined within each of the plurality of protrusions.

14. The method of claim 8 where draining liquid contained within the food item from the device comprises maintaining the device in a vertical position such that liquid removed from the food item exits the device via a nozzle tip disposed in a distal end of the device.

15. The method of claim 8 where squeezing the first half and second half of the device comprises maintaining a constant air pressure between the inside and the outside of the device via an aperture defined in a proximal end of the device.

16. The method of claim 8 where removing the food item from the food device comprises:
releasing a tab disposed on the first half that has been temporarily coupled to a groove disposed on the second half;
rotating the first half about a hinge with respect to the second half; and
picking up the food item from the first or second half of the device.

17. The method of claim 16 where rotating the first half about a hinge with respect to the second half comprises removing a plurality of protrusions disposed on the first half or second half from the food item.
